(19) United States
(12) Patent Application Publication
(10) Pub. No.: US 2009/0145372 A1
(43) Pub. Date: Jun. 11, 2009

(54) Adjustable pet leash

(76) Inventors: Margaret Fithian, Philadelphia, PA (US); John Miceri, Philadelphia, PA (US)

Correspondence Address: HOLLSTEIN KEATING CATTELL JOHNSON & GOLDSTEIN P.C., WILLOW RIDGE EXECUTIVE OFFICE PARK, 750 ROUTE 73 SOUTH, SUITE 301, MARLTON, NJ, 08053, US

(21) Appl. No.: 11/986,479

(22) Filed: Nov. 21, 2007

(51) Int. Cl. A01K 27/00

(52) U.S. Cl. 119/795

(57) ABSTRACT

A walking pet leash has an elongated leash cord secured at one end by a connecting device to the collar of the pet. A loop is provided at the other end of the leash cord. A handle to be held by a user is secured to the leash cord, nearer to the loop end. The size of the loop is adjustable to an infinite number of sized openings to accommodate the hand and wrist of the user. A slideable locking ring permits size adjustment of the loop and, significantly, secures the loop, and hence the leash, around the wrist of the user, preventing the user from losing control of the leash due to overactive and potentially runaway pets.

### BACKGROUND OF THE INVENTION

This invention relates to leashes designed for use in walking pets, especially dogs. There are numerous different types of leashes, many of which attempt to allow the user to maintain control of the leash of an active pet, one who pulls and jerks at the leash, or attempts to run away. Pet owners who have walked their pets are always cognizant about maintaining control of the leash and, hence, ensuring that the leash is not yanked out of their hand, which would permit the pet to run free.

While there have been a number of leash configurations which have attempted to solve this problem, no current leash permits infinite adjustment of the size of the loop section through which the user places his or her hand, nor do existing leashes provide a simple and effective means to secure the leash around the wrist of the user.

### SUMMARY OF THE INVENTION

It is thus an object of the invention to overcome the disadvantages and limitations of prior pet leashes.

It is an object of the subject invention to provide a pet leash which is adjustable to an infinite number of sizes, depending on the configuration, shape, and size of the user.

It is another object of the present invention to provide a pet leash which has a means to secure the leash to the wrist of the user, in order to permit the user, at all times, to maintain control of his or her pet.

It is a further object of the present invention to provide a pet leash which is simple and effective in use and economical in manufacture.

These and other objects are accomplished by the present invention, a walking pet leash which has an elongated leash cord secured at one end by a connecting device to the collar of the pet. A loop is provided at the other end of the leash cord. A handle to be held by a user is secured to the leash cord, nearer to the loop end. The size of the loop is adjustable to an infinite number of sized openings to accommodate the hand and wrist of the user. A slideable locking ring permits size adjustment of the loop and, significantly, secures the loop, and hence the leash, around the wrist of the user, preventing the user from losing control of the leash due to overactive and potentially runaway pets.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 shows the manner of use of the pet leash of the present invention.

FIG. 2 is an elevation view of the pet leash of the present invention.

FIG. 3 is an isometric view of the loop and locking system of the pet leash of the present invention.

FIG. 4 is a top view of the pet leash of the present invention.

FIG. 5 is a close up view of the manner of usage around the wrist of a user of the pet leash of the present invention.

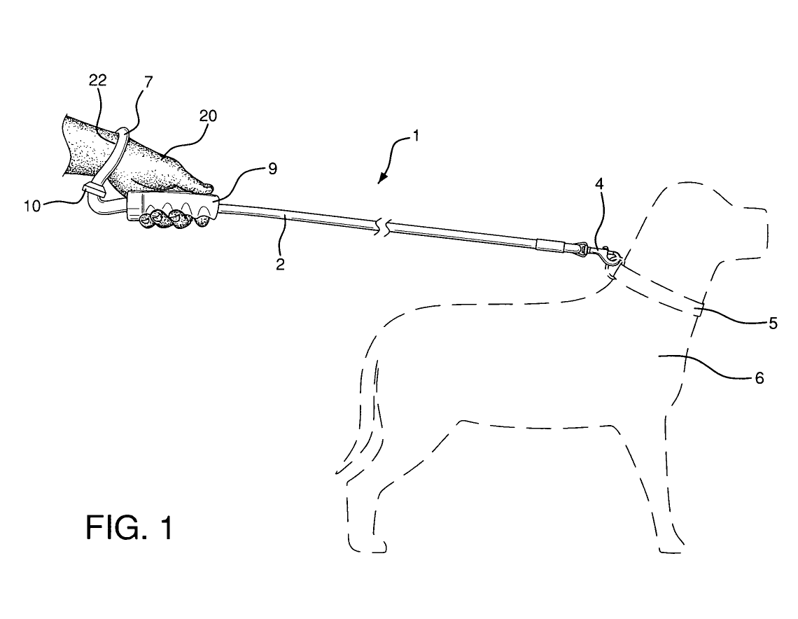

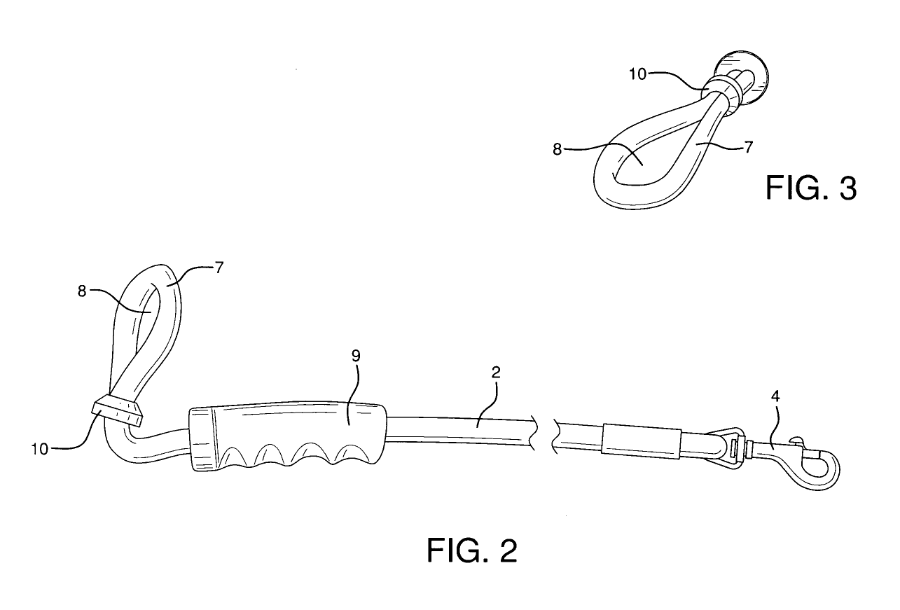

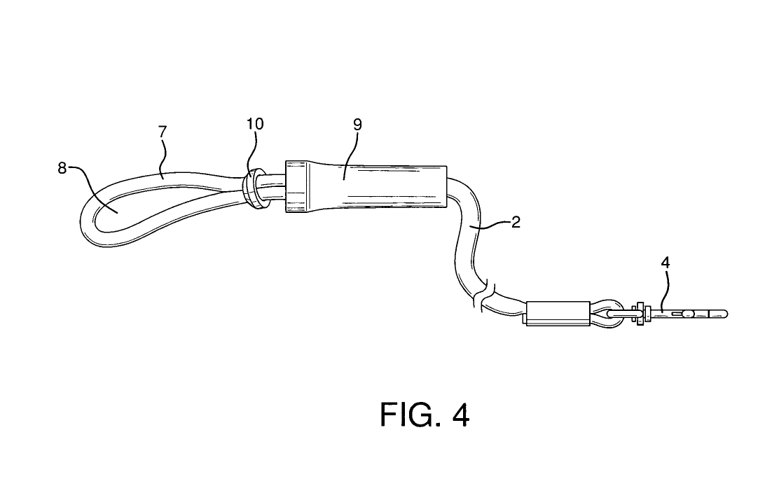

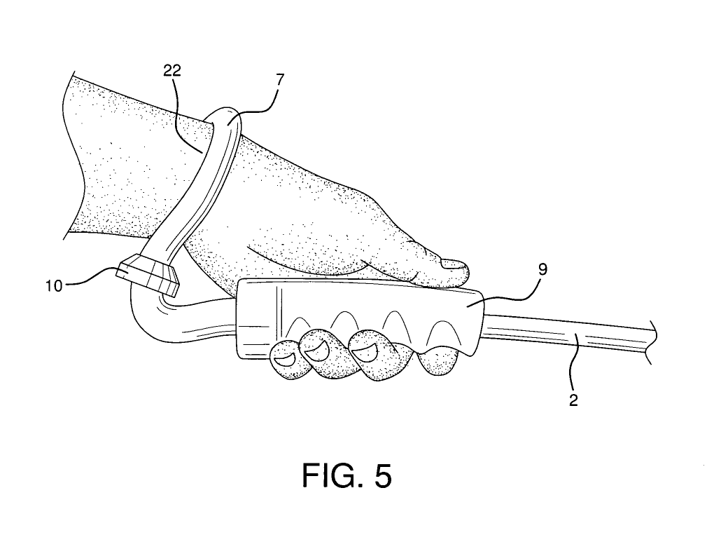

### DETAILED DESCRIPTION OF THE INVENTION

Pet leash 1 of the present invention comprises elongated cord 2, which can be constructed of natural or synthetic rope, polyplastic or like plastic product, or any equivalent, flexible line material. Connecting means 4, such as detachable hook, is attached to one end of cord 2. Connecting means 4 is configured to be attached to collar 5 of the pet 6 to be walked. Loop 7 is located at the other end of cord 2 to allow insertion of hand 20 of a user. Loop 7 is configured to be positioned around wrist 22 of the user. Handle 9 is permanently attached to cord 2, near loop 7, and is designed to be held by the user.

Locking ring 10 is slideably mounted around cord 2 at the base of loop 7. Although it is designed to be slid along cord 2, the internal diameter of locking ring 10 is configured to be only slightly larger than the exterior diameter of the cord, resulting in a friction-tight relationship between the ring and the outer surface of the cord. Thus, some effort is required to slide locking ring 10 along the surface of cord 2 and, given the friction-tight fit, when the ring is adjusted to a given position, it will remain in that position.

The size of loop 7 is controlled by locking ring 10, such that when the locking ring is positioned further from the loop, the size of the loop is increased. As locking ring 10 is slid towards loop 7, its size decreases. In this manner, the size of opening 8 of loop 7 can be adjusted, depending on the size of the hand and wrist of the user.

Significantly, when locking ring 10 is cinched up on loop 7, adjacent to wrist 22 of the user, the loop cannot be loosened from the hand 20 of the user. As a result, even if the user loses control of handle 9 while walking pet 6, leash 1 will remain securely fastened around wrist 22, allowing the user time to gain control of handle 9 and his or her pet 6.

It thus can be readily seen that leash 1 of the present invention provides a simple and efficient solution to the problem of lost leashes and lost pets, due to leashes which are pulled off the wrists of users attempting to walk their animals.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A walking pet leash comprising:
an elongated leash cord with two ends;
connecting means located at one end of the leash cord for attaching the leash cord to the collar of a pet;
loop means located at the second end of the leash cord for maintaining the leash cord around the wrist of the user;
handle means secured to the leash cord near the second end of said leash cord to be held by a user; and
means located near the loop means to secure the leash cord tightly around the wrist of the user, whereby when walking a pet on the leash, the loop means will remain secured around the user's wrist whether or not the user is holding the handle.

2. The walking pet leash as in claim 1 wherein the means to secure the leash cord comprises a locking ring slideably mounted on the leash cord.

3. The walking pet leash as in claim 2 wherein the locking ring is slideably mounted to adjust the size of an opening formed by the loop means.
